(19) United States
(12) Patent Application Publication
(10) Pub. No.: US 2026/0135371 A1
(43) Pub. Date: May 14, 2026

(54) ACTIVE SHORT-CIRCUIT PROTECTION CIRCUIT FOR VEHICLE, EMB SYSTEM, EPS SYSTEM, AND PROTECTION METHOD

(71) Applicant: NEXTEER AUTOMOTIVE (SUZHOU) CO., LTD., Suzhou (CN)

(72) Inventors: Yan (Nemo) LV, Suzhou (CN); Fei (Leo) YANG, Suzhou (CN); Haifeng XU, Suzhou (CN)

(21) Appl. No.: 19/385,562

(22) Filed: Nov. 11, 2025

(30) Foreign Application Priority Data
Nov. 11, 2024 (CN) 2024116030208

(51) Int. Cl. H02H 7/08; B60T 17/18; B62D 5/04; H02M 1/08; H02M 7/5387

(52) U.S. Cl. CPC H02H 7/08; B60T 17/18; B62D 5/0484; H02M 1/08; H02M 7/53871

(57) ABSTRACT

An active short-circuit protection circuit includes: a PWM output switch module connected between an output terminal of a gate drive module and a control terminal of each of lower bridge arm switching transistors of an inverter; a short-circuit protection switch module powered by the battery and converts supplied power into a voltage matching each of the lower bridge arm switching transistors; and a short-circuit protection power supply module connected in series between the short-circuit protection power supply module and the control terminal of each of the lower bridge arm switching transistors, wherein the short-circuit protection switch module is turned on when the voltage of the battery exceeds a specified threshold, to control each of the lower bridge arm switching transistors to be turned on, so that stator windings of the motor are coupled.

### CROSS REFERENCE TO RELATED APPLICATIONS

This U.S. Non-Provisional Patent Application claims priority to Chinese Patent Application Serial No. 2024116030208 filed Nov. 11, 2024, the contents of which are incorporated herein by reference in its entirety.

### TECHNICAL FIELD

The present invention relates to the field of motor control technologies, and in particular, to an active short-circuit protection circuit for a vehicle, an EMB system, an EPS system, and a protection method.

### BACKGROUND ART

With the rapid development of new energy vehicles, safety requirements for new energy vehicles are also increasing. A new energy vehicle is usually driven by a battery-powered motor. When a battery supplies power to the motor, a switching transistor in a power supply line may be damaged due to a fault in the line or an excessively high back electromotive force of the motor, which further aggravates the fault, thereby seriously affecting safe operation of the new energy vehicle.

To effectively rectify the fault in the line of the vehicle, a protection device provided in the conventional technology usually acts on each of switching transistors directly through a control signal, so that the fault is rectified by controlling each of the switching transistors. However, this arrangement has a low safety level, and it is likely that the fault cannot be effectively rectified due to failure of the control signal.

### SUMMARY OF THE INVENTION

Provided in the present invention are an active short-circuit protection circuit for a vehicle, an EMB system, an EPS system, and a protection method, to resolve the problem that a fault in a line cannot be effectively rectified.

According to an aspect of the present invention, provided is an active short-circuit protection circuit for a vehicle, which is applied to a main circuit comprising a battery, an inverter, a gate drive module for driving the inverter, and a motor, wherein the active short-circuit protection circuit for a vehicle comprises:
a PWM output switch module connected in series between an output terminal of the gate drive module and a control terminal of each of lower bridge arm switching transistors of the inverter; and
a short-circuit protection switch module and a short-circuit protection power supply module, wherein the short-circuit protection power supply module is powered by the battery and converts supplied power into a voltage matching each of the lower bridge arm switching transistors, the short-circuit protection switch module is connected in series between the short-circuit protection power supply module and the control terminal of each of the lower bridge arm switching transistors, and the short-circuit protection switch module is turned on when the voltage of the battery exceeds a specified threshold, to control each of the lower bridge arm switching transistors to be turned on, so that stator windings of the motor are coupled;
where the PWM output switch module and the short-circuit protection switch module are not turned on at the same time.

Optionally, the motor is a three-phase motor, and the inverter comprises a first lower bridge arm switching transistor, a second lower bridge arm switching transistor, and a third lower bridge arm switching transistor;
the PWM output switch module comprises a first PWM output switch, a second PWM output switch, and a third PWM output switch, wherein the first PWM output switch is connected in series between a first lower bridge arm control output terminal of the gate drive module and the control terminal of the first lower bridge arm switching transistor, the second PWM output switch is connected in series between a second lower bridge arm control output terminal of the gate drive module and the control terminal of the second lower bridge arm switching transistor, and the third PWM output switch is connected in series between a third lower bridge arm control output terminal of the gate drive module and the control terminal of the third lower bridge arm switching transistor; and/or
the short-circuit protection switch module comprises a first short-circuit protection switch, a second short-circuit protection switch, and a third short-circuit protection switch, wherein the first short-circuit protection switch is connected in series between the short-circuit protection power supply module and the control terminal of the first lower bridge arm switching transistor, the second short-circuit protection switch is connected in series between the short-circuit protection power supply module and the control terminal of the second lower bridge arm switching transistor, and the third short-circuit protection switch is connected in series between the short-circuit protection power supply module and the control terminal of the third lower bridge arm switching transistor.

Optionally, the active short-circuit protection circuit for a vehicle further comprises:
a short-circuit protection enable module, wherein the short-circuit protection enable module outputs a PWM output disable signal and a short-circuit switch enable signal based on a short-circuit enable signal;
a PWM output disable module connected between the short-circuit protection enable module and the PWM output switch module, wherein the PWM output disable module is configured to generate, based on the PWM output disable signal, a control signal for controlling the PWM output switch module to be turned off; and
a short-circuit protection output enable module connected between the short-circuit protection enable module and the short-circuit protection switch module, wherein the short-circuit protection output enable module is configured to generate, based on the short-circuit switch enable signal, a control signal for controlling the short-circuit protection switch module to be turned on.

Optionally, the active short-circuit protection circuit for a vehicle further comprises:
a voltage acquisition module coupled to the battery, wherein the voltage acquisition module is configured to acquire a positive electrode voltage of the battery; and
a main control module connected between the voltage acquisition module and the short-circuit protection enable module, wherein the main control module is configured to output the short-circuit enable signal when the acquired positive electrode voltage exceeds the specified threshold.

Optionally, the active short-circuit protection circuit for a vehicle further comprises:
a circuit status monitoring module coupled to the short-circuit protection enable module and the PWM output disable module, wherein the circuit status monitoring module is configured to monitor operating statuses of the short-circuit protection enable module and the PWM output disable module, and feed back to the main control module.

Optionally, the output terminal of the gate drive module is directly coupled to each of upper bridge arm switching transistors of the inverter; and
the PWM output disable module is further coupled to the gate drive module, and is configured to control, based on the PWM output disable signal, each of the upper bridge arm switching transistors to be turned off.

Optionally, the active short-circuit protection circuit for a vehicle further comprises:
a phase output status monitoring module coupled to the stator windings of the motor, wherein the phase output status monitoring module is configured to monitor a voltage of the stator windings of the motor, and feed back to the main control module.

According to another aspect of the present invention, provided is an EMB system comprising a main circuit and the active short-circuit protection circuit for a vehicle according to any embodiment of the present invention.

According to another aspect of the present invention, provided is an EPS system comprising a main circuit and the active short-circuit protection circuit for a vehicle according to any embodiment of the present invention.

According to another aspect of the present invention, provided is an active short-circuit protection method for a vehicle, which is applied to the active short-circuit protection circuit for a vehicle according to any embodiment of the present invention, wherein the active short-circuit protection method for a vehicle comprises:
obtaining a positive electrode voltage of the battery; and
if the positive electrode voltage of the battery exceeds a specified threshold, controlling each of the upper bridge arm switching transistors of the inverter to be turned off, and controlling each of the lower bridge arm switching transistors of the inverter to be turned on, so that the stator windings of the motor are coupled.

According to the technical solutions provided in the embodiments of the present invention, with the PWM output switch module and the short-circuit protection switch module, when a fault occurs in the line, a connection between the gate drive module and each of the lower bridge arm switching transistors of the inverter may be interrupted by using the PWM output switch module, and a voltage of the short-circuit protection power supply module may be input into each of the lower bridge arm switching transistors by turning on the short-circuit protection switch module, so that each of the lower bridge arm switching transistors is turned on, and the stator windings of the motor are short-circuited, thereby rectifying the fault. The PWM output switch module may physically disconnect the gate drive module from each of the lower bridge arm switching transistors. Even if an output signal of the gate drive module fails, each of the lower bridge arm switching transistors can be turned on by using the short-circuit protection switch module and the short-circuit protection power supply module, thereby achieving active short-circuit protection. This arrangement has a high safety level, so that the fault in the line can be effectively rectified.

It should be understood that the content described in this section is neither intended to identify key or important features of the embodiments of the present invention, nor intended to limit the scope of the present invention. Other features of the present invention will become readily apparent from the following description.

### BRIEF DESCRIPTION OF THE DRAWINGS

To describe the technical solutions in the embodiments of the present invention more clearly, the drawings required for the description of the embodiments will be briefly described below. Clearly, the drawings described below are merely some embodiments of the present invention. For those of ordinary skill in the art, other drawings may be derived from these drawings without creative efforts.

FIG. 1 is a block diagram of an active short-circuit protection circuit for a vehicle according to an embodiment of the present invention;

FIG. 2 is a block diagram of another active short-circuit protection circuit for a vehicle according to an embodiment of the present invention;

FIG. 3 is a block diagram of still another active short-circuit protection circuit for a vehicle according to an embodiment of the present invention;

FIG. 4 is a block diagram of still another active short-circuit protection circuit for a vehicle according to an embodiment of the present invention; and

FIG. 5 is a flowchart of an active short-circuit protection method for a vehicle according to an embodiment of the present invention.

### DETAILED DESCRIPTION OF EMBODIMENTS

To enable those skilled in the art to better understand the solutions of the present invention, the technical solutions in the embodiments of the present invention are described clearly and completely below with reference to the accompanying drawings in the embodiments of the present invention. Clearly, the described embodiments are only some rather than all embodiments of the present invention. On the basis of the embodiments of the present invention, all other embodiments obtained by those of ordinary skill in the art without creative efforts shall fall within the protection scope of the present invention.

It should be noted that the terms “first”, “second”, etc. in the specification, claims and accompanying drawings of the present invention are used to distinguish between similar objects, and are not necessarily used to describe a specific order or sequence. It should be understood that data used in this manner may be interchanged as appropriate, so that the embodiments of the present invention described herein can be implemented in an order other than those illustrated or described herein. In addition, the terms “include”, “have”, and any variations thereof are intended to cover a non-exclusive inclusion, for example, a process, method, system, product, or device that includes a series of steps or units is not necessarily limited to those steps or units explicitly listed, but may include other steps or units not explicitly listed or inherent to such a process, method, product, or device.

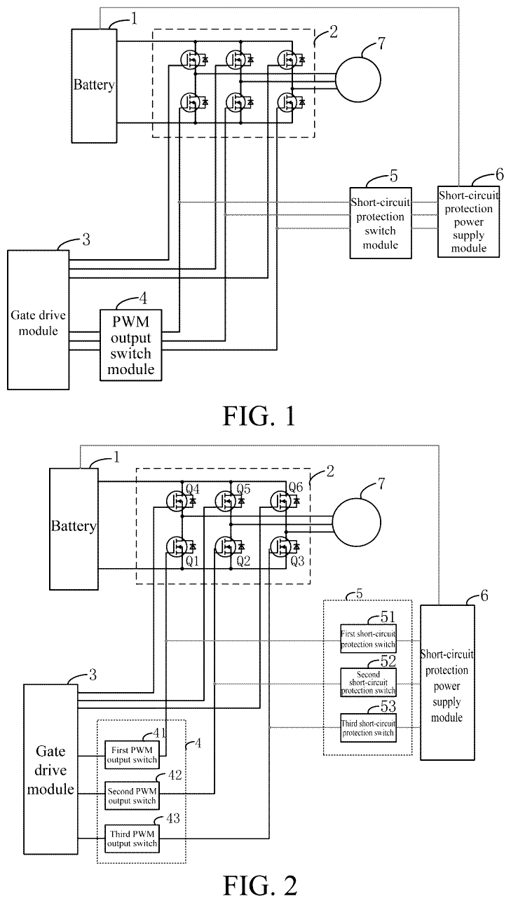

Provided in an embodiment of the present invention is an active short-circuit protection circuit for a vehicle, which is applied to a main circuit including a battery 1, an inverter 2, a gate drive module 3 for driving the inverter 2, and a motor 7. FIG. 1 is a block diagram of an active short-circuit protection circuit for a vehicle according to an embodiment of the present invention. Referring to FIG. 1, the active short-circuit protection circuit for a vehicle includes a PWM output switch module 4, a short-circuit protection switch module 5, and a short-circuit protection power supply module 6. The PWM output switch module 4 is connected in series between an output terminal of the gate drive module 3 and a control terminal of each of lower bridge arm switching transistors of the inverter 2. The short-circuit protection power supply module 6 is powered by the battery 1 and converts supplied power into a voltage matching each of the lower bridge arm switching transistors, the short-circuit protection switch module 5 is connected in series between the short-circuit protection power supply module 6 and the control terminal of each of the lower bridge arm switching transistors, and the short-circuit protection switch module 5 is turned on when the voltage of the battery 1 exceeds a specified threshold, to control each of the lower bridge arm switching transistors to be turned on, so that stator windings of the motor 2 are coupled. The PWM output switch module 4 and the short-circuit protection switch module 5 are not turned on at the same time.

During operation of the motor 7, the battery 1 supplies power to the motor 7 by using the inverter 2. When a fault occurs in a power supply line, for example, when a fault occurs in the battery 1 or a back electromotive force of the motor 7 is higher than the maximum breakdown voltage that can be withstood by the switching transistors, the switching transistors of the inverter 2 may be broken down by a fault voltage, which may aggravate the fault. To prevent further escalation of the fault, the gate drive module 3 may control switching transistors connected to the gate drive module 3 to be turned off. In this case, if the switching transistors are broken down, a fault current or a fault voltage may still form a loop. In addition, as the result of direct control through the gate drive module 3, the switching transistors possibly cannot be effectively controlled due to failure of a control signal. Therefore, the switching transistors of the inverter 2 need to be further adjusted.

Specifically, to ensure safe operation of each of the switching transistors and prevent each of the switching transistors from being broken down by a fault voltage, the PWM output switch module 4 may be turned off to interrupt a connection between the gate drive module 3 and each of lower bridge arm switching transistors of the inverter 2, and thus interrupt control of the gate drive module 3 over the lower bridge arm switching transistor. Moreover, the short-circuit protection switch module 5 is turned on, and the voltage converted by the short-circuit protection power supply module 6 may be directly input to the control terminal of each of the lower bridge arm switching transistors by using the short-circuit protection switch module 5. For example, the voltage of the battery 1 may be 12 V, and the short-circuit protection power supply module 6 may convert the 12 V voltage of the battery 1 into a fixed voltage of 11.5 V. Each of the lower bridge arm switching transistors is turned on upon receiving the voltage output by the short-circuit protection power supply module 6. In this case, the stator windings of the motor 7 are short-circuited, which is equivalent to disconnecting a loop between the battery 1 and the motor 7, thereby preventing further aggravation of the fault, so that each of the switch transistors of the inverter 2 does not withstand an excessively high voltage, and thus protecting each of the switching transistors of the inverter 2.

According to the technical solution provided in this embodiment of the present invention, with the PWM output switch module 4 and the short-circuit protection switch module 5, when a fault occurs in the line, a connection between the gate drive module 3 and each of the lower bridge arm switching transistors of the inverter 2 may be interrupted by using the PWM output switch module 4, and a voltage of the short-circuit protection power supply module 6 may be input into each of the lower bridge arm switching transistors by turning on the short-circuit protection switch module 5, so that each of the lower bridge arm switching transistor is turned on, and the stator windings of the motor 7 are short-circuited, thereby rectifying the fault. The PWM output switch module 4 may physically disconnect the gate drive module 3 from each of the lower bridge arm switching transistors. Even if an output signal of the gate drive module 3 fails, each of the lower bridge arm switching transistors can be turned on by using the short-circuit protection switch module 5 and the short-circuit protection power supply module 6, thereby achieving active short-circuit protection. This arrangement has a high safety level, so that the fault in the line can be effectively rectified.

FIG. 2 is a block diagram of another active short-circuit protection circuit for a vehicle according to an embodiment of the present invention. Referring to FIG. 2, on the basis of the above embodiments, optionally, the motor 7 is a three-phase motor, and the inverter 2 includes a first lower bridge arm switching transistor Q1, a second lower bridge arm switching transistor Q2, and a third lower bridge arm switching transistor Q3. The PWM output switch module 4 includes a first PWM output switch 41, a second PWM output switch 42, and a third PWM output switch 43, wherein the first PWM output switch 41 is connected in series between a first lower bridge arm control output terminal of the gate drive module 3 and the control terminal of the first lower bridge arm switching transistor Q1, the second PWM output switch 42 is connected in series between a second lower bridge arm control output terminal of the gate drive module 3 and the control terminal of the second lower bridge arm switching transistor Q2, and the third PWM output switch 43 is connected in series between a third lower bridge arm control output terminal of the gate drive module 3 and the control terminal of the third lower bridge arm switching transistor Q3. And/or, the short-circuit protection switch module includes a first short-circuit protection switch 51, a second short-circuit protection switch 52, and a third short-circuit protection switch 53, wherein the first short-circuit protection switch 51 is connected in series between the short-circuit protection power supply module 6 and the control terminal of the first lower bridge arm switching transistor Q1, the second short-circuit protection switch 52 is connected in series between the short-circuit protection power supply module 6 and the control terminal of the second lower bridge arm switching transistor Q2, and the third short-circuit protection switch 53 is connected in series between the short-circuit protection power supply module 6 and the control terminal of the third lower bridge arm switching transistor Q3.

When a fault such as overvoltage occurs in the line, the first PWM output switch 41, the second PWM output switch 42, and the third PWM output switch 43 are instantly turned off, thereby interrupting a connection between the gate drive module 3 and each of the lower bridge arm switching transistors of the inverter 2. Moreover, the first short-circuit protection switch 51, the second short-circuit protection switch 52, and the third short-circuit protection switch 53 are turned on, the voltage of the short-circuit protection power supply module 6 is input into the first lower bridge arm switching transistor Q1, the second lower bridge arm switching transistor Q2, and the third lower bridge arm switching transistor Q3 through the first short-circuit protection switch 51, the second short-circuit protection switch 52, and the third short-circuit protection switch 53, respectively, and a voltage difference is formed between a gate and a source of each of the switching transistors, so that the first lower bridge arm switching transistor Q1, the second lower bridge arm switching transistor Q2, and the third lower bridge arm switching transistor Q3 are all turned on, and thus the stator windings of the motor 7 are short-circuited, thereby achieving active short-circuit protection. In addition, none of the switching transistors is broken down by a high voltage, thereby ensuring high safety.

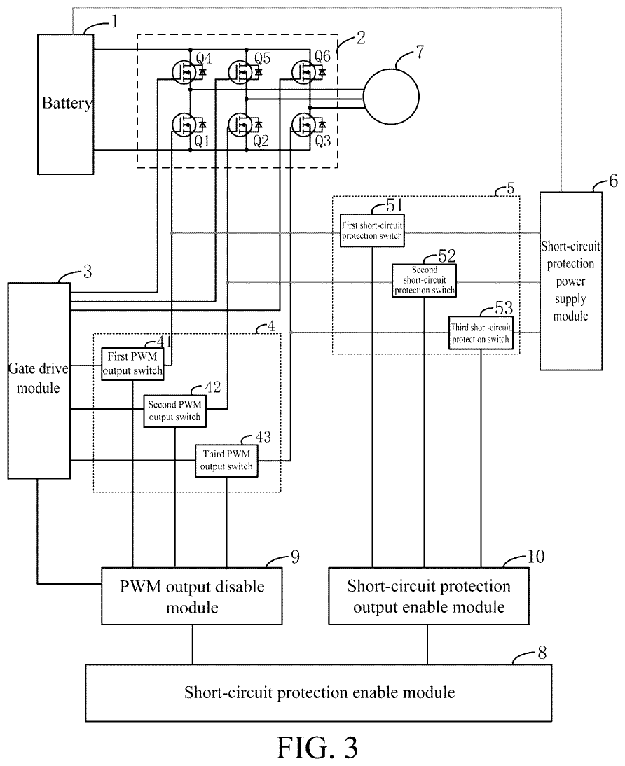

FIG. 3 is a block diagram of still another active short-circuit protection circuit for a vehicle according to an embodiment of the present invention. Referring to FIG. 3, on the basis of the above embodiments, optionally, the active short-circuit protection circuit for a vehicle further includes a short-circuit protection enable module 8, a PWM output disable module 9, and a short-circuit protection output enable module 10.The short-circuit protection enable module 8 outputs a PWM output disable signal and a short-circuit switch enable signal based on a short-circuit enable signal; the PWM output disable module 9 is connected between the short-circuit protection enable module 8 and the PWM output switch module 4, wherein the PWM output disable module 9 is configured to generate, based on the PWM output disable signal, a control signal for controlling the PWM output switch module 4 to be turned off; and the short-circuit protection output enable module 10 is connected between the short-circuit protection enable module 8 and the short-circuit protection switch module 5, wherein the short-circuit protection output enable module 10 is configured to generate, based on the short-circuit switch enable signal, a control signal for controlling the short-circuit protection switch module 5 to be turned on.

Optionally, the output terminal of the gate drive module 3 is directly coupled to each of upper bridge arm switching transistors of the inverter 2.The PWM output disable module 9 is further coupled to the gate drive module 3, and is configured to control, based on the PWM output disable signal, each of the upper bridge arm switching transistors to be turned off.

The upper bridge arm switching transistor may include a first upper bridge arm switching transistor Q4, a second upper bridge arm switching transistor Q5, and a third upper bridge arm switching transistor Q6.When the battery 1 and the motor 7 operate normally and no fault occurs in the line, the gate drive module 3 may control each of the upper bridge arm switching transistors and the lower bridge arm switching transistors of the inverter 2 to invert a direct current output by the battery 1 into an alternating current and input the alternating current into the motor 7.

When a fault such as overvoltage occurs in the line, the short-circuit protection enable module 8 may receive a short-circuit enable signal, and generate a PWM output disable signal and a short-circuit switch enable signal based on the short-circuit enable signal. The PWM output disable signal is received by the PWM output disable module 9, and the PWM output disable module 9 may control, based on the signal, the first PWM output switch 41, the second PWM output switch 42, and the third PWM output switch 43 to be turned off, thereby interrupting a connection between the gate drive module 3 and each of the lower bridge arm switching transistors of the inverter 2. The PWM output disable module 9 may further input the signal to the gate drive module 3, and the gate drive module 3 controls the first upper bridge arm switching transistor Q4, the second upper bridge arm switching transistor Q5, and the third upper bridge arm switching transistor Q6 to be turned off.

The short-circuit switch enable signal is received by the short-circuit protection output enable module 10, and the short-circuit protection output enable module 10 may control, based on the signal, the first short-circuit protection switch 51, the second short-circuit protection switch 52, and the third short-circuit protection switch 53 to be turned on, so that the voltage of the short-circuit protection power supply module 6 is input into the first lower bridge arm switching transistor Q1, the second lower bridge arm switching transistor Q2, and the third lower bridge arm switching transistor Q3 through the first short-circuit protection switch 51, the second short-circuit protection switch 52, and the third short-circuit protection switch 53, respectively, so that the first lower bridge arm switching transistor Q1, the second lower bridge arm switching transistor Q2, and the third lower bridge arm switching transistor Q3 are turned on, and thus the stator windings of the motor 7 are short-circuited, thereby achieving active short-circuit protection.

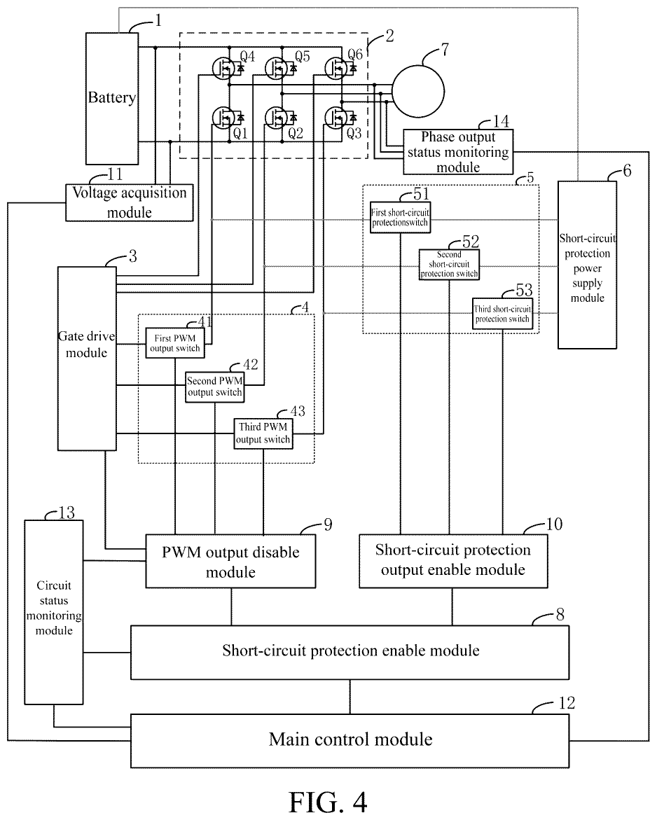

FIG. 4 is a block diagram of still another active short-circuit protection circuit for a vehicle according to an embodiment of the present invention. Referring to FIG. 4, on the basis of the above embodiments, optionally, the active short-circuit protection circuit for a vehicle further includes a voltage acquisition module 11 and a main control module 12. The voltage acquisition module 11 is coupled to the battery 1, wherein the voltage acquisition module 11 is configured to acquire a positive electrode voltage of the battery 1; and the main control module 12 is connected between the voltage acquisition module 11 and the short-circuit protection enable module 8, wherein the main control module 12 is configured to output the short-circuit enable signal when the acquired positive electrode voltage exceeds the specified threshold.

The voltage acquisition module 11 may be configured to detect the voltage at an output terminal of the battery 1 and input the voltage to the main control module 12. When the positive electrode voltage exceeds the specified threshold, the main control module 12 may generate a short-circuit enable signal and input the short-circuit enable signal into the short-circuit protection enable module 8 to control active short-circuit protection among the stator windings of the motor 7.

Still referring to FIG. 4, on the basis of the above embodiments, optionally, the active short-circuit protection circuit for a vehicle further includes: a circuit status monitoring module 13 coupled to the short-circuit protection enable module 8 and the PWM output disable module 9, wherein the circuit status monitoring module 13 is configured to monitor operating statuses of the short-circuit protection enable module 8 and the PWM output disable module 9, and feed back to the main control module 12.

When the short-circuit protection enable module 8 and the PWM output disable module 9 output signals, a feedback signal is also output to the circuit status monitoring module 13 at the same time. The feedback signal may be used to indicate whether the PWM output disable signal and the short-circuit switch enable signal of the short-circuit protection enable module 8 are effectively output, and whether the PWM output disable module 9 generates, based on the PWM output disable signal, a control signal for controlling the PWM output switch module 4 to be turned off and effectively outputs the control signal. The circuit status monitoring module 13 may feed back the feedback signal to the main control module 12.When the short-circuit protection enable module 8 or the PWM output disable module 9 fails to effectively output a signal, the main control module 12 may generate the short-circuit enable signal again and re-input the short-circuit enable signal into the short-circuit protection enable module 8 to generate the PWM output disable signal and the short-circuit switch enable signal, so as to ensure effective implementation of active short-circuit protection.

Still referring to FIG. 4, on the basis of the above embodiments, optionally, the active short-circuit protection circuit for a vehicle further includes: a phase output status monitoring module 14 coupled to the stator windings of the motor 7, wherein the phase output status monitoring module 14 is configured to monitor a voltage of the stator windings of the motor 7, and feed back to the main control module 12.

The phase output status monitoring module 14 may verify, by detecting the voltage of the stator windings of the motor 7, whether an active short circuit among the stator windings is completed. For example, when the inverter 2 inverts a direct current output by the battery 1 into a three-phase (phases A, B, and C) alternating current, the stator windings of the motor 7 are powered by the three-phase (phases A, B, and C) alternating current in the line, and the phase output status monitoring module 14 may monitor a phase A voltage U_{A}, a phase B voltage U_{B}, and a phase C voltage U_{C}, and input the voltages into the main control module 12. When U_{A}=0, U_{B}=0, and U_{C}=0, it indicates that the stator windings of the motor 7 are successfully short-circuited.

Further provided in an embodiment of the present invention is an EMB system. The system includes a main circuit and the active short-circuit protection circuit for a vehicle according to any embodiment of the present invention. The system has corresponding functional modules and beneficial effects of the active short-circuit protection circuit for a vehicle. Details are not described herein again.

The EMB system (electromechanical brake system) is an electronic brake system that uses an electronic control unit instead of a traditional hydraulic or pneumatic brake system to control a brake actuator. The EMB system has advantages such as a rapid response, high control precision, easy integration into an electronic system of a vehicle, and space saving.

Further provided in an embodiment of the present invention is an EPS system. The system includes a main circuit and the active short-circuit protection circuit for a vehicle according to any embodiment of the present invention. The system has corresponding functional modules and beneficial effects of the active short-circuit protection circuit for a vehicle. Details are not described herein again.

The EPS (electric power steering) system is a power steering system that directly relies on a motor to provide auxiliary torque. The EPS system can adjust power in real time based on parameters such as a vehicle speed and a steering angle, so that a steering operation is more convenient and flexible, and handling stability and safety of the vehicle can be improved. The EPS system has advantages such as energy saving, environmental protection, a compact structure, and reliable performance.

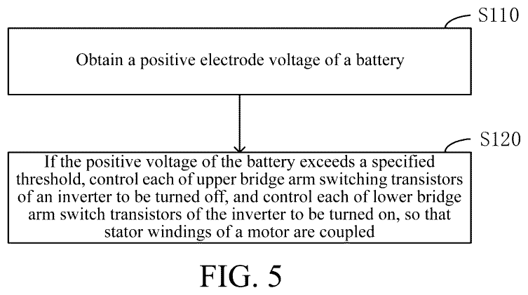

Further provided in an embodiment of the present invention is an active short-circuit protection method for a vehicle. FIG. 5 is a flowchart of an active short-circuit protection method for a vehicle according to an embodiment of the present invention. Referring to FIG. 5, the method may be performed by a main control module. The method is applied to the active short-circuit protection circuit for a vehicle according to any embodiment of the present invention, and has corresponding functional modules and beneficial effects of the active short-circuit protection circuit for a vehicle. The active short-circuit protection method for a vehicle includes:
S110: obtaining a positive electrode voltage of the battery; and
S120: if the positive electrode voltage of the battery exceeds a specified threshold, controlling each of the upper bridge arm switching transistors of the inverter to be turned off, and controlling each of the lower bridge arm switching transistors of the inverter to be turned on, so that the stator windings of the motor are coupled.

When the positive electrode voltage of the battery exceeds the specified threshold, an overvoltage fault may occur in the line, the gate drive module may control each of the upper bridge arm switching transistors of the inverter to be turned off, and a short-circuit current protection module may input a fixed voltage to each of the lower bridge arm switching transistors of the inverter through the short-circuit protection switch module, so that each of the lower bridge arm switching transistor of the inverter is turned on, and the stator windings of the motor are coupled.

According to the technical solution provided in the embodiments of the present invention, the fault is rectified by independently controlling each of the upper bridge arm switching transistors and each of the lower bridge arm switching transistors of the inverter and by short-circuiting the stator windings of the motor. Even if an output signal of the gate drive module fails, each of the lower bridge arm switching transistors can be turned on by using the short-circuit protection switch module and the short-circuit protection power supply module, thereby achieving active short-circuit protection, which provides a higher level of safety, so that the fault in the line can be effectively rectified.

It should be understood that the various forms of processes shown above may be used to reorder, add, or delete steps. For example, the steps described in the present invention may be performed in parallel, sequentially, or in a different order, as long as the desired results of the technical solutions of the present invention can be achieved, which is not limited herein.

The above specific embodiments do not constitute a limitation on the protection scope of the present invention. It should be understood by those skilled in the art that various modifications, combinations, sub-combinations and substitutions may be made based on design requirements and other factors. Any modifications, equivalent replacements and improvements made within the spirit and principle of the present invention shall be included in the protection scope of the present invention.

1. An active short-circuit protection circuit for a vehicle, applied to a main circuit comprising a battery, an inverter, a gate drive module for driving the inverter, and a motor, wherein the active short-circuit protection circuit for a vehicle comprises:
a pulse-width modulation (PWM) output switch module connected in series between an output terminal of the gate drive module and a control terminal of each of lower bridge arm switching transistors of the inverter; and
a short-circuit protection switch module and a short-circuit protection power supply module, wherein the short-circuit protection power supply module is powered by the battery and converts supplied power into a voltage matching each of the lower bridge arm switching transistors, the short-circuit protection switch module is connected in series between the short-circuit protection power supply module and the control terminal of each of the lower bridge arm switching transistors, and the short-circuit protection switch module is turned on when the voltage of the battery exceeds a specified threshold, to control each of the lower bridge arm switching transistors to be turned on, so that stator windings of the motor are coupled; wherein
the PWM output switch module and the short-circuit protection switch module are not turned on at the same time.

2. The active short-circuit protection circuit of claim 1, wherein the motor is a three-phase motor, and the inverter comprises a first lower bridge arm switching transistor, a second lower bridge arm switching transistor, and a third lower bridge arm switching transistor;
the PWM output switch module comprises a first PWM output switch, a second PWM output switch, and a third PWM output switch, wherein the first PWM output switch is connected in series between a first lower bridge arm control output terminal of the gate drive module and the control terminal of the first lower bridge arm switching transistor, the second PWM output switch is connected in series between a second lower bridge arm control output terminal of the gate drive module and the control terminal of the second lower bridge arm switching transistor, and the third PWM output switch is connected in series between a third lower bridge arm control output terminal of the gate drive module and the control terminal of the third lower bridge arm switching transistor; and/or
the short-circuit protection switch module comprises a first short-circuit protection switch, a second short-circuit protection switch, and a third short-circuit protection switch, wherein the first short-circuit protection switch is connected in series between the short-circuit protection power supply module and the control terminal of the first lower bridge arm switching transistor, the second short-circuit protection switch is connected in series between the short-circuit protection power supply module and the control terminal of the second lower bridge arm switching transistor, and the third short-circuit protection switch is connected in series between the short-circuit protection power supply module and the control terminal of the third lower bridge arm switching transistor.

3. The active short-circuit protection circuit of claim 1, further comprising:
a short-circuit protection enable module, wherein the short-circuit protection enable module outputs a PWM output disable signal and a short-circuit switch enable signal based on a short-circuit enable signal;
a PWM output disable module connected between the short-circuit protection enable module and the PWM output switch module, wherein the PWM output disable module is configured to generate, based on the PWM output disable signal, a control signal for controlling the PWM output switch module to be turned off; and
a short-circuit protection output enable module connected between the short-circuit protection enable module and the short-circuit protection switch module, wherein the short-circuit protection output enable module is configured to generate, based on the short-circuit switch enable signal, a control signal for controlling the short-circuit protection switch module to be turned on.

4. The active short-circuit protection circuit of claim 3, further comprising:
a voltage acquisition module coupled to the battery, wherein the voltage acquisition module is configured to acquire a positive electrode voltage of the battery; and
a main control module connected between the voltage acquisition module and the short-circuit protection enable module, wherein the main control module is configured to output the short-circuit enable signal when the positive electrode voltage exceeds the specified threshold.

5. The active short-circuit protection circuit of claim 3, further comprising:
a circuit status monitoring module coupled to the short-circuit protection enable module and the PWM output disable module, wherein the circuit status monitoring module is configured to monitor operating statuses of the short-circuit protection enable module and the PWM output disable module, and feed back to the main control module.

6. The active short-circuit protection circuit of claim 1, wherein the output terminal of the gate drive module is directly coupled to each of upper bridge arm switching transistors of the inverter;
and
the PWM output disable module is further coupled to the gate drive module, and is configured to control, based on the PWM output disable signal, each of the upper bridge arm switching transistors to be turned off.

7. The active short-circuit protection circuit of claim 1, further comprising:
a phase output status monitoring module coupled to the stator windings of the motor, wherein the phase output status monitoring module is configured to monitor a voltage of the stator windings of the motor, and feed back to the main control module.

8. The active short-circuit protection circuit of claim 1, wherein the main circuit is associated with an electromechanical brake system.

9. The active short-circuit protection circuit of claim 1, wherein the main circuit is associated with an electronic power steering system.

10. The active short-circuit protection circuit of claim 1, wherein the short-circuit protection switch module:
obtains a positive electrode voltage of the battery; and
if the positive electrode voltage of the battery exceeds a specified threshold:
controls one or more upper bridge arm switching transistors of the inverter to be turned off; and
controls each of the lower bridge arm switching transistors of the inverter to be turned on, so that the stator windings of the motor are coupled.

11. An active short-circuit protection circuit comprising:
a pulse-width modulation (PWM) output switch module that includes a first PWM output switch connected in series between a first lower bridge arm control output terminal of a gate drive module, a second PWM output switch connected in series between a second lower bridge arm control output terminal of the gate drive module, and a third PWM output switch connected in series between a third lower bridge arm control output terminal of the gate drive module;
a short-circuit protection power supply module configured to convert battery voltage to a respective voltage at each of the first lower bridge arm control output terminal, the second lower bridge arm control output terminal, and the third lower bridge arm control output terminal; and
a short-circuit protection switch module that turns on in response to the battery voltage exceeding a threshold, causing respective transistors of each of the first lower bridge arm control output terminal, the second lower bridge arm control output terminal, and the third lower bridge arm control output terminal to conduct, coupling stator windings of an associated motor.

12. The active short-circuit protection circuit of claim 11, wherein the motor is associated with an electromechanical brake system.

13. The active short-circuit protection circuit of claim 11, wherein the motor is associated with electronic power steering system.

14. The active short-circuit protection circuit of claim 11, further comprising a short-circuit protection enable module.

15. The active short-circuit protection circuit of claim 14, wherein the short-circuit protection enable module outputs a PWM output disable signal and a short-circuit switch enable signal based on a short-circuit enable signal.

16. The active short-circuit protection circuit of claim 14, further comprising a PWM output disable module connected between the short-circuit protection enable module and the PWM output switch module.

17. The active short-circuit protection circuit of claim 16, wherein the PWM output disable module is configured to generate, based on the PWM output disable signal, a control signal for controlling the PWM output switch module to be turned off.

18. The active short-circuit protection circuit of claim 16, further comprising a short-circuit protection output enable module connected between the short-circuit protection enable module and the short-circuit protection switch module.

19. The active short-circuit protection circuit of claim 18, wherein the short-circuit protection output enable module is configured to generate, based on the short-circuit switch enable signal, a control signal for controlling the short-circuit protection switch module to be turned on.

20. An active short-circuit protection method comprising:
a pulse-width modulation (PWM) output switch module that includes a first PWM output switch connected in series between a first lower bridge arm control output terminal of a gate drive module, a second PWM output switch connected in series between a second lower bridge arm control output terminal of the gate drive module, and a third PWM output switch connected in series between a third lower bridge arm control output terminal of the gate drive module;
converting, using a short-circuit protection power supply module, battery voltage to a respective voltage at each of a first lower bridge arm control output terminal of a pulse-width modulation (PWM) output switch module, a second lower bridge arm control output terminal of the PWM output switch module, and the third lower bridge arm control output terminal of the PWM output switch module, wherein the of the PWM output switch module includes a first PWM output switch connected in series between the first lower bridge arm control output terminal of a gate drive module, a second PWM output switch connected in series between the second lower bridge arm control output terminal of the gate drive module, and a third PWM output switch connected in series between the third lower bridge arm control output terminal of the gate drive module; and
in response to the battery voltage exceeding a threshold, turning on a shirt-circuit protection switch module that causes (i) respective transistors of each of the first lower bridge arm control output terminal, the second lower bridge arm control output terminal, and the third lower bridge arm control output terminal to conduct, and (ii) coupling stator windings of an associated motor.
